(19) United States
(12) Patent Application Publication
(10) Pub. No.: US 2004/0262805 A1
(43) Pub. Date: Dec. 30, 2004

(54) Leather stylized steering wheel

(76) Inventors: William E. Bostick, St. Clair, MI (US); Alex Konig, Port Huron, MI (US)

Correspondence Address: Laurence C. Begin, Dinnin & Dunn, P.C., Suite 500, 2701 Cambridge Court, Auburn Hills, MI, 48326, US

(21) Appl. No.: 10/610,052

(22) Filed: Jun. 30, 2003

(51) Int. Cl. B29C 33/40

(52) U.S. Cl. 264/162; 264/259; 264/240; 264/219

(57) ABSTRACT

A method of manufacturing a steering wheel is provided that includes the steps of placing the steering wheel in a molding tool and injecting a flowable, curable composition therein. The molding tool has internal surfaces contoured to impart to articles molded therein the appearance of genuine leather. The parting line or splitline of the molding tool is positioned such that it is substantially aligned with a region of the molding tool contoured to impart to the article molded therein the appearance of a seam on a leather wrapped steering wheel. A method of forming a molding tool for injection molding a steering wheel having a covering is also provided. The method includes the step of forming a separable molding tool from a replica of a leather wrapped steering wheel, the molding tool having regions proximate an interface of the mold portions contoured according to the stitched leather around the outer periphery of the wrapped steering wheel core.

### TECHNICAL FIELD

The present invention relates generally to methods of manufacturing steering wheels for motor vehicles, and more particularly to such a method wherein the steering wheel is formed with a covering having the appearance of leather.

### BACKGROUND OF THE INVENTION

Automotive engineers and designers have long sought to create vehicles having aesthetically pleasing exterior and interior designs. In particular, leather coverings for interior trim, seats, and steering wheels are the hallmark of a high-quality automobile. A perennial countervailing interest in the industry, however, is price. Thus, while the look and feel of genuine leather are nearly always desirable, design contests are often won by less expensive, synthetic materials. For example, in many vehicles, vinyl seat coverings are typically used instead of leather. Not only are the synthetic starting materials usually less expensive than genuine cowhide, manufacturing and installation tend to be less labor-intensive.

To balance opposing concerns of aesthetic appeal and price in automotive interior design, various synthetic materials and manufacturing methods have been developed wherein a non-leather composition is formulated, treated or otherwise modified to mimic the appearance and feel of genuine leather. Where steering wheels are concerned, various methods and compositions resembling genuine leather wrapping have been developed. One known method of molding a leather-type steering wheel involves placing a steering wheel core in an injection molding apparatus, and subsequently injecting a curable elastomeric composition that forms a molded layer coating the core. The molded covering may then be mechanically buffed or ground and/or etched with acids or other corrosive materials in such a way that the outer surface takes on an appearance similar to leather. Such post-molding processes increase the material cost, require the use of potentially hazardous materials, and can be relatively labor-intensive.

A further shortcoming of injection molding designs is related to the use of conventional separable molding tools. As is well known in the injection molding arts, there is a tendency for excess scrap material to adhere to the outer surface of the elastomeric covering after completion of a molding cycle. Because molding processes typically involve injection of relatively flowable material, often at significant pressures, the elastomeric composition has a tendency to flow or be forced into the relatively small gap between the mold portions, and solidify therein. After removal from the mold, much of this excess material may be trimmed from the molded steering wheel covering; however, it is difficult to completely obscure the region in the finished product where the excess molding material was deposited. This region is generally referred to in the molding arts as a “splitline.” These imperfections in the molding apparatus and process are believed to detract from the overall aesthetic appeal of the molded article. Where a finished design akin to leather is desired, splitlines and other imperfections may belie the synthetic nature of the product.

The present invention is directed to one or more of the problems or shortcomings associated with the related art.

### SUMMARY OF THE INVENTION

It is an object of the present invention to provide a method of manufacturing a steering wheel having a molded covering with the look and feel of genuine leather.

It is a further object of the present invention to provide a method of forming a molding tool for injection molding a covering for a steering wheel, wherein the molding tool has regions proximate an interface of the mold portions contoured according to a seam region of a leather-wrapped steering wheel from which the molding tool is formed.

In one aspect, the present invention provides a method of manufacturing a steering wheel having a core and a molded covering. The method preferably comprises the steps of positioning a steering wheel core in a molding tool having separable portions internally contoured to impart an appearance of leather to portions of an article molded therein. The molding tool further preferably includes regions proximate an interface of the mold portions contoured to impart an appearance of a seam to an article molded therein. The method further preferably comprises the step of closing the portions of the molding tool about the steering wheel core, and injecting a flowable curable composition into the molding tool. Upon curing, the composition forms a molded layer over the steering wheel core. The method further preferably comprises the step of separating the portions of the molding tool, the interface of the two portions defining splitlines in the molded layer substantially aligned with portions of the molded layer resembling seams.

In another aspect, the present invention provides a method of forming a molding tool for injection molding a covering for a steering wheel. The method preferably comprises the steps of wrapping leather around the rim of a steering wheel, followed by joining adjacent edges of the wrapped leather by stitching the leather at least around an outer periphery of the wrapped steering wheel. The method further preferably comprises the steps of forming a first mold that is a negative replica of the leather wrapped steering wheel, and molding a positive replica of the steering wheel according to the first mold. The method further preferably comprises the step of forming a second mold according to the positive replica that is a separable negative molding tool, wherein the second mold includes regions proximate an interface of the mold portions contoured according to the stitched leather around the outer periphery of the wrapped steering wheel core.

### BRIEF DESCRIPTION OF THE DRAWINGS

FIG. 1 is a perspective view of a portion of a steering wheel formed according to a preferred embodiment of the present invention;

FIG. 2 is a perspective view of a portion of a steering wheel formed according to a second preferred embodiment of the present invention;

FIG. 3 is a perspective view of a portion of a steering wheel formed according to a third preferred embodiment of the present invention;

FIG. 4 is a perspective view of a portion of a steering wheel formed according to a fourth preferred embodiment of the present invention;

FIG. 5 is a perspective view of a portion of a steering wheel formed according to a fifth preferred embodiment of the present invention;

FIG. 6 is a partial sectioned side view of a molding apparatus according to a preferred embodiment of the present invention.

### DETAILED DESCRIPTION OF PREFERRED EMBODIMENTS

The present invention comprises a process for manufacturing a steering wheel having a core and a covering injection-molded thereover. The steering wheel is manufactured in such a way that the covering has the appearance and feel of natural leather. Elastomeric compositions are most preferred for forming the covering, however, alternative materials might be used without departing from the scope of the present invention. In a preferred embodiment metallic steering wheel cores are utilized, preferably aluminum or magnesium, however, plastic or some other type of steering wheel cores could be used without departing from the scope of the present invention. The steering wheel cores preferably used with the present invention can be prepared according to any known method such as milling or casting. The method preferably comprises placing the steering wheel core in a mold, then subsequently injecting a flowable, curable elastomeric composition therein to substantially fill the space around the core, forming a solid adherent layer molded around the metallic core, in a manner well known in the art. Because the utilized molding tool has the negative shape of a steering wheel, the molded product obtained from the process of the present invention takes on the shape of the mold, including details of the surface contours of the mold surfaces. Various known compositions can be injected, however, an elastomeric composition capable of being foamed is preferred, giving the molded layer a resilient texture. After the composition is cured, the steering wheel is removed from the molding apparatus.

Various finishing steps may be undertaken prior to final assembly in the vehicle. For instance, the steering wheel may be coated with soft-touch paint, known in the art. Soft touch paint imparts a soft feel due to silicone beads or other additives known in the industry. The preferred paint is a water-based formulation produced by Red Spot, Inc., of Lexington, Mich. In many cases, it will be desirable to manually trim excess molded covering from the steering wheel prior to final assembly to enhance the aesthetic appeal of the product. Further, the walls of the mold cavity may be treated with a release agent prior to an injection molding cycle to facilitate removal of the molded article, or painted with a material that chemically bonds with the elastomeric composition, for example, forming a one-layer bond. Preferred mold paints are water-based, and have a chemistry such that the potential for post-molding paint splitting is minimized by ensuring a chemical bond/mix between the paint and the elastomeric covering. All of the materials necessary for practicing the present invention are known in the art and are readily commercially available.

A typical manufacturing cycle according to the present invention begins with the step of positioning the steering wheel core in a separable molding tool that is a negative image of a steering wheel. Stated another way, the tool is formed such that material formed therein is molded into an article having the shape of a steering wheel. The molding apparatus when closed provides a clearance between the core and the interior surfaces of the mold that is approximately equal to the desired thickness of the molded covering. The molding tool is preferably a two-piece metallic, separable mold that includes mold portions having internal surfaces contoured to impart to articles molded therein the appearance of genuine leather. A variety of methods might be used for contouring the mold surfaces to have the leather appearance, including known techniques such as etching, abrasion, etc., however, the molding tool is preferably manufactured by forming the tool from an actual leather-wrapped steering wheel, imparting the surface texture of genuine leather and leather seams to the mold surfaces. In a preferred embodiment, the rim portion of the steering wheel is molded such that it has the appearance of leather, and the spokes and armature portions of the steering wheel are molded to resemble a non-leather material such as textured vinyl. It has been found that imparting differing grains to the armature and spokes than to the rim enhances the aesthetic appearance of the finished steering wheel. However, it should be appreciated that alternative designs are possible without departing from the scope of the present invention.

Referring to FIG. 6, there is shown in cross section a portion of an exemplary separable molding tool 511 having upper 512 and lower 514 mold portions, with a molded steering wheel 510 positioned therebetween. Steering wheel 510 comprises a metallic core 516 and a molded elastomeric covering 518. Molding tool 511 is preferably formed from a genuine leather-wrapped steering wheel, and thus has mold surfaces contoured to impart a leather-like texture to articles molded therein. The exemplary molding tool shown in FIG. 6 further includes regions proximate an interface of the mold portions that are contoured to resemble seams on a leather steering wheel covering, imparting similar characteristics to articles molded therein. Upper and lower portions 512, 514 each preferably define approximately half of the region of the molded article having the appearance of a seam, hereafter the “seam region,” designated 515 in FIG. 6. Stated another way, the mold portions preferably have a parting line/plane proximate the middle of the molded seam region. The present process may be undertaken with molds having any of a wide variety of surface contours proximate the mold interface, producing a corresponding variety of molded articles without departing from the scope of the present invention. The seam region of the molded article may be formed having, for example, the appearance of internally or externally stitched leather.

After the steering wheel is placed in the molding tool, the tool is closed and the flowable, curable elastomeric composition is injected and allowed to cure, forming a layer surrounding the steering wheel core that is externally molded in conformity with the internal surface contours of the mold. The composition is preferably a multi-component reactive mixture that is mixed by essentially simultaneous injection into the mold. Pigment may be added to the mixture to produce steering wheels having the desired coloration, although coloring may also be achieved by selecting an appropriately colored soft-touch paint that is sprayed on the steering wheel. In a preferred embodiment, the elastomeric composition is formulated to produce carbon dioxide upon reaction between the two components and/or a catalyst, which forms bubbles in the cured elastomer, giving it a resilient, spongy foamed consistency. Suitable compositions contemplated for use with the presently described process contain, for example, an “A” and a “B” component, one of which is an isocyanate, whereupon curing the components form a solid polyurethane foam having a relatively continuous outer skin. If desired, a catalyst and/or separate foaming agent may be included in the formulation. In a preferred embodiment, the compositions are formulated such that a delay of approximately 6 seconds occurs before solidification of the reaction products. It should be appreciated that the present invention is applicable to essentially any known elastomeric formulation suitable for injection molding, both single and double shot formulations, many of which are known in the art. Examples of suitable compositions are described in U.S. Pat. No. 4,994,502 to Markavs et al, herein incorporated by reference, and U.S. Pat. No. 4,292,211, also incorporated by reference herein.

Following curing of the elastomeric composition, the mold is opened and the molded steering wheel is removed from the mold. The cured elastomeric material forms a layer covering the steering wheel core, and having external surfaces molded in conformity with the internal surface texture of the mold. During the molding process, the flowable elastomeric material has a tendency to flow or to be forced between the separable mold portions. FIG. 6 illustrates thin layers of molded elastomeric material on opposite sides of the molded covering 518, extending between the mold portions 512 and 514. Upon separating the mold portions, this solidified elastomeric material typically protrudes from the outer and inner peripheries of the molded rim of the steering wheel, from which it is trimmed. However, even after trimming, a feature known in the molding arts as the “splitline” tends to be evident on the molded product along the plane corresponding to the interface of the mold portions. Thus, a thin, low ridge of molded elastomeric material is left around the outer and inner peripheries of the steering wheel rim. This splitline is a discontinuity in the surface texture of the covering. Because molding tool 511 is formed such that the seam region 515 is located approximately where the mold portions are brought together, seam region 515 and the splitline are substantially aligned. Alignment of the splitline with the seam region is believed to substantially lessen the visibility of the splitline, and therefore enhances the likeness of the molded covering to genuine leather. Those skilled in the art will appreciate that most molding tools utilized in accordance with the present invention tend to create splitlines on both an outer periphery of the steering wheel rim, and the inner periphery of the rim. Both splitlines correspond to an interface of the mold portions, i.e. regions where the molding tool portions are substantially adjacent when the mold is closed. Splitline(s) along the inner periphery of the steering wheel rim are generally less visible than splitlines around the outer periphery of the steering wheel, and therefore tend to detract less from the aesthetic appeal of the steering wheel. Nevertheless, in a preferred embodiment, the steering wheel is molded to include seam regions around the outer periphery as well as the inner periphery of the steering wheel rim.

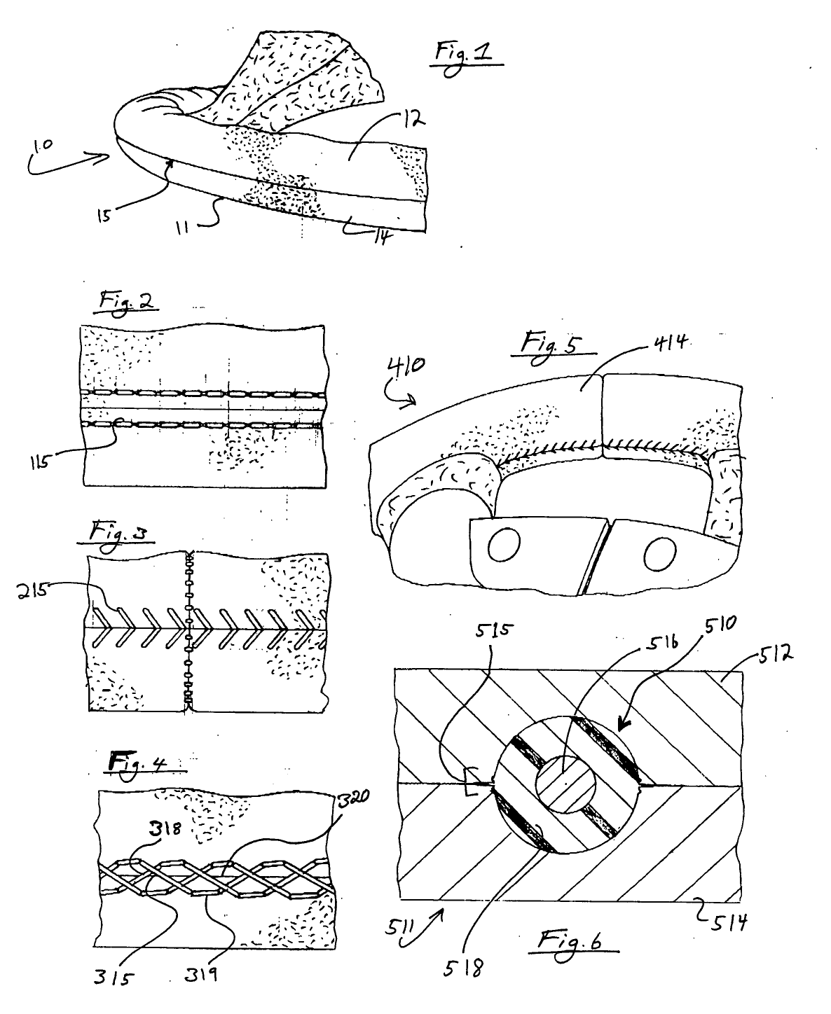

Referring to FIG. 1, there is shown a portion of a steering wheel 10 formed according to the process of the present invention, having a rim 11. Steering wheel 10 includes an upper molded portion 12 and a lower molded portion 14. A molded seam region 15 separates the respective upper and lower portions. Steering wheel 10 is formed such that seam region 15 has the appearance of an internally stitched seam. In accordance with the present invention, upon separating the mold portions the splitline around the molded covering (not shown) is substantially aligned with seam region 15. The seam region 15 is molded to have the appearance of a butt seam, i.e. a seam wherein two pieces of material (leather) are folded inwardly along adjoining edges and internally sewn together in a manner well known in the art. Those skilled in the art will appreciate that as used herein the term “internally” refers to stitches formed substantially on the inside of the wrapped leather, and essentially not visible on the exterior of the molded covering. “Externally” refers to stitches visible on the exterior of the molded covering. FIG. 2 illustrates a butt seam with a machine stitch wherein the molded stitches are oriented substantially parallel to the orientation of the seam region and the splitline. In the FIG. 2 embodiment, the stitches are preferably positioned on each side of the seam region 115. Turning to FIG. 3, there is shown a steering wheel formed according to the present invention that incorporates a molded region having the appearance of a “baseball stitch,” a well-known style of joining adjacent pieces of leather. In general, a seam region having molded baseball stitches comprises multiple molded stitches extending in two sets on either side of the seam region 215. A first end 216 of each molded stitch terminates proximate the center of the seam region 215, while a second end 217 of each molded stitch terminates laterally of the seam region 215, as shown in FIG. 3, wherein each stitch extends diagonally from the center of the seam region. Turning to FIG. 4, there is shown a molded “Euro” or “Z” stitch comprising first and second lines 318 and 319, respectively, of stitching arranged laterally of, and substantially parallel with the seam region 315. The Z stitch further comprises a molded stitch 320 extending medially of the first and second lines 318 and 319, and having the appearance of looping alternately between the first and second lines 318 and 319, as shown in FIG. 4. FIG. 5 represents yet another steering wheel 410 formed according to the present invention. Steering wheel 410 comprises a molded butt seam 414 that is circumferential of the rim 411 and oriented perpendicular to a line tangent to a periphery of the rim. Stated another way, molded butt seam 414 encircles the rim 411.

In another aspect, the present invention comprises a method of forming a molding tool for injection molding of an elastomeric covering for a steering wheel core. The method preferably begins with the step of wrapping leather around the rim of a steering wheel. The utilized steering wheel preferably comprises a conventional metallic steering wheel core that is cast, milled or produced by another method to remove a thickness of metal that is approximately equal to the thickness of the leather (and any desired padding) wrapped thereon. It is emphasized, however, that essentially any material or structure having a shape similar to a steering wheel can be used as the underlying body upon which the leather is wrapped. The steering wheel utilized may be formed from, for example, aluminum, magnesium, steel, even a resin or other elastomeric material. Once the leather is wrapped about the steering wheel, adjoining edges of the leather are sewn to secure the leather to the core. In a preferred embodiment, the leather is wrapped such that adjoining edges of the leather are positioned circumferentially around an external periphery of the steering wheel. Various means for stitching the wrapped leather are contemplated, including internally stitching the leather pieces to form a butt seam circumferential of the steering wheel or externally stitching the leather with various stitching styles. For example, Z-stitches, baseball stitches, and machine stitches are contemplated, as described herein. A wide variety of different stitching styles and stitch positioning are contemplated, dictated only by the style of mold to eventually be produced.

Once stitched, a curable material is poured over and allowed to cure around the steering wheel. Once solidified, the material can be cut away from the steering wheel to yield a negative replica of the leather-wrapped steering wheel. Thus, the negative replica is a multi-piece mold having a cavity in the shape of the original steering wheel. This step can be carried out by any known method; however, the preferred method is by forming a silicone casting of the steering wheel. In this process, a curable liquid silicone composition is poured over the leather wrapped steering wheel and allowed to cure. Silicones are preferred because the fluid mold material is capable of flowing about and effectively defining the relatively detailed features of the wrapped steering wheel, including the leather and the stitching thereof. The negative silicone replica is then used in the step of forming a positive replica of the steering wheel, preferably by curing a relatively hard composition, such as an acrylic or epoxy therein. For example, a minimally shrinking epoxy formulation available from Hartz Bondo of Germany has been found suitable for molding the positive replica.

After the positive replica is formed, a separable negative molding tool, preferably metallic, is formed from the positive replica. In a preferred embodiment, the separable negative molding tool is a two-piece negative image of the original leather wrapped steering wheel, imparting to articles molded therein a shape substantially identical to the original leather wrapped steering wheel. The separable negative molding tool is formed such that the mold portions are contoured in regions proximate an interface thereof in accordance with the stitched leather seam around the outer periphery of the original leather wrapped steering wheel, an example of which is illustrated in FIG. 6. The wrapped steering wheel used for the original model can be wrapped and stitched in any known fashion, and there is therefore a wide variety of stitching and seam styles that can be imparted to the molding tool that is the final product. In a preferred embodiment, the metallic molding tool is formed by electrodeposition of metallic particles onto the positive replica, in a manner well known in the art. An aqueous or vapor deposition process is preferably used wherein the positive replica serves as an electrode placed in an aqueous or vapor environment of available metallic ions, which adhere to the replica to form a solid metallic structure/block surrounding the replica. The metallic block may then be cut into two separable mold portions, the parting line of which is substantially aligned with the portions of the mold that are formed complementarily to the seams on the original leather wrapped steering wheel. One preferred process takes place with the use of a silver-plated bath model/replica dipped into a liquid solution of nickel ions for electrodeposition on the silver-plated model. The process may take place by electrodepositing nickel on a whole, i.e. uncut, silver-plated steering wheel or, alternatively, the silver-plated steering wheel may be cut into two halves, and the halves of the molding tool formed separately.

The present invention allows an aesthetically pleasing steering wheel having the appearance of leather to be manufactured without the material and labor costs of genuine leather. Furthermore, the look and feel of the steering wheel is superior to related designs wherein the molding splitline/trim line is not obscured by a molded region having the appearance of a seam. Finally, the use of soft touch paint in a preferred embodiment further enhances the aesthetic appeal.

The present description is for illustrative purposes only, and should not be construed to narrow the scope of the present invention in any way. Thus, those skilled in the art will appreciate that various modifications might be made to the presently disclosed embodiments without departing from the intended spirit and scope of the present invention. Other aspects, features and advantages will be apparent upon an examination of the attached drawing figures and appended claims.

What is claimed:

1. A method of manufacturing a steering wheel having a core and a molded covering, the method comprising the steps of:
positioning a steering wheel core in a molding tool having separable portions internally contoured to impart an appearance of leather to portions of an article molded therein, and having regions proximate an interface of the mold portions contoured to impart an appearance of a seam to an article molded therein;
closing the portions of the molding tool about the steering wheel core;
injecting a flowable curable composition into the molding tool, whereupon curing the composition forms a molded layer over the steering wheel core; and
separating the portions of the molding tool, the interface of the two portions defining splitlines in the molded layer substantially aligned with portions of the molded layer resembling seams.

2. The method of claim 1 wherein at least a portion of the region proximate the interface of the portions of the molding tool is contoured to impart an appearance of external peripheral stitching to the article molded therein.

3. The method of claim 2 wherein the molded layer is formed having an appearance of peripheral Z-stitching.

4. The method of claim 2 wherein the molded layer is formed having an appearance of peripheral baseball stitching.

5. The method of claim 2 wherein the molded layer is formed having the appearance of a peripheral butt seam.

6. The method of claim 1 wherein the molded layer is formed having an appearance of a butt seam circumferential of a rim portion of the steering wheel and oriented perpendicular to a line tangent to a periphery of the rim.

7. The method of claim 1 wherein at least a portion of the region proximate the interface of the two halves of the molding tool is contoured to impart to an article molded therein an appearance of an internally stitched seam.

8. The method of claim 1 further comprising the step of applying a layer of soft touch paint to the exterior of the molded layer.

9. The method of claim 1 wherein the step of injecting a curable composition into the mold comprises injecting a multi-component elastomeric formulation.

10. The method of claim 1 wherein the mold portions are formed such that the interface thereof defines a first splitline traversing an exterior periphery of the steering wheel rim, and at least a second splitline traversing an interior periphery of the steering wheel rim.

11. The method of claim 1 wherein the step of providing a separable molding tool comprises providing a separable molding tool having mold surfaces contoured to impart a leather appearance to the rim of the steering wheel molded therein.

12. The method of claim 1 wherein the surfaces of the mold portions are contoured to impart differing grain structures to the body and the rim, respectively, of the steering wheel molded therein.

13. A method of forming a molded covering over an article core comprising the steps of:
placing a core in a separable molding tool, the molding tool having interior surfaces contoured to impart to an article molded therein an exterior surface region having the appearance of a seam proximate an interface of portions of the molding tool;
injecting a flowable curable composition into the molding tool;
allowing the flowable curable material to cure;
opening the molding tool, a splitline in the cured molded material overlaying the region having the appearance of a seam.

14. A method of forming a molding tool for injection molding a covering for a steering wheel, the method comprising the steps of:
wrapping leather around the rim of a steering wheel;
joining adjacent edges of the wrapped leather by stitching the leather at least around an outer periphery of the wrapped steering wheel;
forming a first mold that is a negative replica of the leather wrapped steering wheel;
molding a positive replica of the steering wheel according to the first mold;
forming a second mold according to the positive replica that is a separable negative molding tool, wherein the second mold includes regions proximate an interface of the mold portions contoured according to the stitched leather around the outer periphery of the wrapped steering wheel.

15. The method of claim 14 wherein the step of joining adjacent edges of the wrapped leather comprises externally stitching the wrapped leather.

16. The method of claim 14 wherein the step of joining adjacent edges of the wrapped leather comprises internally stitching the wrapped leather.

17. The method of claim 14 wherein the step of forming a second mold comprises an electrodeposition process.

18. The method of claim 14 further comprising the step of milling the steering wheel prior to the wrapping step, thereby removing a layer of material having a thickness substantially equal to the thickness of the leather subsequently wrapped thereon.

19. A method of forming a tool for molding a steering wheel covering, the method comprising the steps of:
positioning a leather covering about the rim of a steering wheel;
forming a molding tool using the steering wheel as a template.

20. The method of claim 19 wherein:
the positioning step further comprises positioning the leather covering such that adjoining edges of the covering are oriented substantially circumferential of an outer periphery of the steering wheel.
